(19) United States
(12) Patent Application Publication
(10) Pub. No.: US 2006/0223529 A1
(43) Pub. Date: Oct. 5, 2006

(54) Data processing apparatus for probe traffic information and data processing system and method for probe traffic information

(76) Inventors: Takayoshi Yokota, Hitachiota (JP); Takashi Moita, Yokohama (JP); Itaru Oda, Chiba (JP); Satoshi Sugawara, Kimitsu (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/359,376

(22) Filed: Feb. 23, 2006

(30) Foreign Application Priority Data
Mar. 31, 2005 (JP) 2005-103599

(51) Int. Cl. H04Q 7/20

(52) U.S. Cl. 455/433; 455/453; 455/441

(57) ABSTRACT

By utilizing a cell phone carried by a driver or a fellow passenger to exchange with a base station during talking (through polling during non-talking), position information of the cell phone is obtained. The position information is collected and gathered as probe data and by matching the data with road map data, traffic congestion information on roads is generated. Then, when a business car of a driver carrying a cell phone is not traveling in a range initially predicted, it is decided whether position data of the cell phone is suitable as probe information and accurate traffic congestion information is generated.

### BACKGROUND OF THE INVENTION

The present invention relates to systems for generating traffic information by utilizing probe information and, more particularly, to a data processing system for probe traffic information which includes, as a probe terminal, a cell phone (cellular phone) having its position presumed through communication with a base station and uses the terminal position as probe data to generate congestion information based on map data on the basis of position information that specifies the inside of an area of the base station associated with the cell phone and besides, to a probe traffic information data processing apparatus and a probe traffic information data processing method.

In order to calculate the shortest time route from the present place to a destination by making use of a car navigation system, not only map information but also road congestion information about road congestion on a scheduled route is needed. For generation of the road congestion information, it is necessary to watch movement of a car running on a road. With the aim of calculating the congestion information by watching the movement of a car, there are available a method of calculating congestion information by using a traffic information system pursuant to, for example, VICS and a calculation method based on probe information gathered from a probe car mounted with a GPS.

For calculation of the congestion information by using the traffic information system pursuant to VICS, it is necessary that roadside sensors be installed on sides of roads all the country over to gather such data of a car passing by sensors as its traveling speed and traveling time over a section, into a center and the information be accumulated to generate traffic information.

To acquire the congestion information through the method as above, however, a great number of roadside sensors must be installed on sides of roads throughout the country (national roads, rapid transit highway roads, prefectural roads and so on), resulting in a problem of high costs. And also, for generation of the congestion information by means of the probe car carrying a GPS receiver, a number of probe cars actually running on roads must be assured and costs of communicating position information from the cars to the center are needed, so that a problem still remains unsolved in generating minute congestion information all the country over.

Conventionally, a traffic condition presuming method using a probe car and making use of probe information to realize traffic condition prediction/presumption in an area in which the probe car is not running at present and a traffic condition presuming/presenting system have been proposed (described in, for example, U.S. Pat. No. 6,546,330). In the traffic condition presuming method and traffic condition presuming/presenting system described in U.S. Pat. No. 6,546,330, as structurally depicted in its FIG. 1, respective probe cars 101 and 102 transmit probe information 103 indicative of times and position in areas in which each probe car has traveled to a center 104 and a traffic condition presumption means 105 in the center 104 accumulates the probe information 103 in a probe information database 106 and uses current probe information 103 and data accumulated from past to present in the probe information database 106 to presume forward area forecast traffic jam information 120 and backward area presumption traffic jam information 121 of each of the probe cars 101 and 102.

### SUMMARY OF THE INVENTION

In the traffic condition presuming method and traffic condition presuming/presenting system described in the aforementioned U.S. Pat. No. 6,546,330, probe car data is utilized and a GPS receiver is mounted in a target car for the sake of acquiring probe information, position information obtained with the GPS receiver is sent to a probe center by using communication means such as a cell phone and the probe center needs to accumulate the collected information to generate traffic information, facing a problem that communication costs are raised.

An object of the present invention is to provide a data processing apparatus for probe traffic information capable of eliminating the aforementioned prior art problems and probe traffic information data processing system and method using the probe traffic information data processing apparatus.

According to one aspect of the present invention, a data processing system for probe traffic information is provided which can generate congestion information all the country over with minimized capital investment by presuming the position of a cell phone on the basis of information concerning talking and non-talking with a base station associated with the cell phone, using the position information as probe data and matching the probe data with road map data to generate traffic congestion information on roads.

According to another aspect of the present invention, a data processing apparatus for probe traffic information is provided which can generate traffic congestion information on roads by presuming the position of a cell phone on the basis of information concerning talking and non-talking with a base station associated with the cell phone, gathering the position information of the cell phone as probe data, processing the data and matching the data with road map data to generate traffic congestion information on roads.

According to still another aspect of the invention, a data processing method for probe traffic information is provided which can generate traffic congestion information on roads by presuming the position of a cell phone on the basis of information concerning talking and non-talking with a base station associated with the cell phone, gathering the position information of the cell phone as probe data, processing the data and matching the data with road map data to generate traffic congestion information on roads.

In the present invention, a sector position information database stores position information of respective ones of a plurality of sectors defined by dividing a communication area of respective ones of a plurality of base stations, a road map information database stores road map information of roads running through the communication areas of the individual plural base stations, the information stored in the sector position information database and the information stored in the road map information database are consulted to calculate traveling time and traveling distance of a moving body from position data before the information changes and position data after the information changes and traffic information is generated from the calculated information.

Further, a data processing system for probe traffic information according to the invention comprises a processor having a CPU and a memory unit and a cell phone connected to the processor through a communication circuit and being mobile along with a car, the cell phone being provided with drive mode input means,

wherein the memory unit of the data processing system includes a cell phone non-talking period information database for storing information obtained from the cell phone through polling during non-talking over the cell phone, a base station position information database for storing position information of respective one of a plurality of base stations, a sector position information database for storing position information of respective ones of a plurality of sectors defined by dividing a communication area each of the plural base stations has, a map information database for storing map information of neighborhoods inclusive of the communication areas of the plural base stations, a road information database for storing information of roads running through the communication areas of the plural base stations and an area information database for storing area information of each sector each communication area of each base station has, and

wherein, in the data processing system, the area information of each sector each communication area of each base station has is watched at a constant period; the cell phone is determined as traveling when the area information watched at the constant period changes; a traveling speed of the car is calculated from traveling time and traveling distance of the car on the basis of position data before the area information changes and position data after the area information changes; and the traveling speed is compared with a legal speed stored in the road information database to determine a jam when the traveling speed is smaller than the legal speed beyond a first predetermined range and to determine a congestion state when the moving speed is smaller than the legal speed beyond a second predetermined range.

Further, a data processing system for probe traffic information according to the present invention comprises a processor having a CPU and a memory unit and a cell phone connected to the processor through a communication circuit and being mobile along with a car, the cell phone being provided with drive mode input means,

wherein the memory unit of the data processing system includes a cell phone talking period information database for storing information obtained from the cell phone during talking over the cell phone, a base station position information database for storing position information of respective ones of a plurality of base stations, a sector position information database for storing position information of respective ones of a plurality of sectors defined by dividing a communication area of each of the plural base stations, a map information database for storing map information of neighborhoods inclusive of the communication areas of the plural base stations and a road information database for storing information of roads running through the communication areas of the plural base stations, and

wherein, in the data processing system, first cell phone information is acquired which is presented from the cell phone at a point where talking over the cell phone is started; second cell phone information is acquired which is presented from the cell phone at a point where talking over the cell phone is ended; traveling time and traveling distance of the car are calculated on the basis of the first cell phone information and second cell phone information; a traveling speed of the car is calculated from the traveling time and traveling distance of the car; and the traveling speed is compared with a legal speed stored in the road information database to determine a jam when the traveling speed is smaller than the legal speed beyond a first predetermined range, a congestion state when the traveling speed is smaller than the legal speed beyond a second predetermined range and a normal state in other cases.

Further, a data processing apparatus for probe traffic information according to the invention comprises a processor having a CPU and a memory unit and a cell phone connected to the processor through a communication circuit and being mobile along with a car, the cell phone being provided with drive mode input means,

wherein the memory unit of the data processing apparatus includes a cell phone non-talking period information database for storing information obtained from the cell phone through polling during non-talking over the cell phone, a cell phone talking period information database for storing information obtained from the cell phone during talking over the cell phone, a base station position information database for storing position information of respective ones of a plurality of base stations, a sector position information database for storing position information of respective ones of a plurality of sectors defined by dividing a communication area of each of the plural base stations, a map information database for storing map information of neighborhoods inclusive of the communication areas of the plural base stations, a road information database for storing information of roads running through the communication areas of the plural base stations and an area information database for storing area information of each sector each communication area of each base station has,

wherein, in the data processing apparatus, the area information of each sector each communication area of each base station has is watched at a constant period and when the area information watched at the constant period changes, the cell phone is determined as traveling and a traveling speed of the car is calculated from traveling time and traveling distance of the car on the basis of position data before the area information changes and position data after the area information changes, and

wherein, in the data processing apparatus, during talking over the cell phone, first cell phone information is acquired which is presented from the cell phone at a point where talking over the cell phone is started; second cell phone information is acquired which is presented from the cell phone at a point where talking over the cell phone is ended; traveling time and traveling distance of the car are calculated on the basis of the first cell phone information and second cell phone information; a traveling speed of the car is calculated from the traveling time and traveling distance of the car; and the traveling speed is compared with a legal speed stored in the road information database to determine a jam or congestion state when the traveling speed is smaller than the legal speed beyond a first or second predetermined range, with the jam being determined when the traveling speed is smaller than the legal speed beyond the first predetermined range and the congestion being determined when the traveling speed is smaller than the legal speed beyond the second predetermined range and a normal state being determined in other cases.

Further, a data processing method for probe traffic information according to the invention comprises:

a first step of reading, on the basis of talking log information of a cell phone subscriber recorded and saved in a system of a cell phone, traveling time and traveling distance of a cell phone carrier between a point where talking is started and a point where talking is ended;

a second step of calculating a traveling speed (speed per hour) of the cell phone carrier from the traveling time and traveling distance of the cell phone carrier read out in the first step;

a third step of putting aside and choosing a value of traveling speed remarkably slower than the lowest speed (speed per hour) of a car running on a corresponding specified road from the traveling speed (speed per hour) of the cell phone carrier calculated in the second step; and

a fourth step of comparing the traveling speed (speed per hour) of the cell phone carrier chosen in the third step with a legal speed for the specified road to determine a jam or congestion state when the traveling speed is slower than the legal speed.

According to the data processing system for probe traffic information, congestion information throughout the country can be generated with minimized capital investment by presuming the position of a cell phone from information concerning talking and non-talking over the cell phone with a base station, using the position information as probe data and matching the probe data with road map data to generate traffic congestion information on roads.

Further, according to the data processing apparatus for probe traffic information according to the invention, traffic congestion information on roads can be generated by presuming the position of a cell phone on the basis of information concerning talking and non-talking over the cell phone with a base station, gathering the position information of the cell phone as probe data, processing the data and matching the data with road map data.

Furthermore, according to the data processing method for probe traffic information according to the invention, traffic congestion information throughout the country can be generated with minimized capital investment by presuming the position of a cell phone on the basis of information concerning talking and non-talking over the cell phone with a base station, using the position information as probe data and matching the data with road map data to generate traffic congestion information on roads.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram of a system configuration, showing the construction of data processing system for probe traffic information and data processing apparatus for probe traffic information and a data processing method for probe traffic information according to an embodiment of the present invention.

FIG. 2 is a block diagram showing the construction of the data processing apparatus for probe traffic information shown in FIG. 1.

FIG. 3 is a diagram showing details of a memory unit shown in FIG. 2.

FIG. 4 is a diagram useful in explaining a method for acquisition of probe information.

### DETAILED DESCRIPTION OF THE EMBODIMENT

In the present invention, generation of traffic congestion information on roads can be realized by utilizing a cell phone a cell phone carrier on board a car has, gathering position information of the cell phone obtained through exchange with a base station during talking (or through polling during non-talking) as probe data and matching the data with road map data.

In case a car driven by a driver with a cell phone does not travel inside an originally predicted range, accurate traffic congestion information can be generated when position data of the cell phone is decided as to whether to be suitable as probe information.

### Embodiment 1

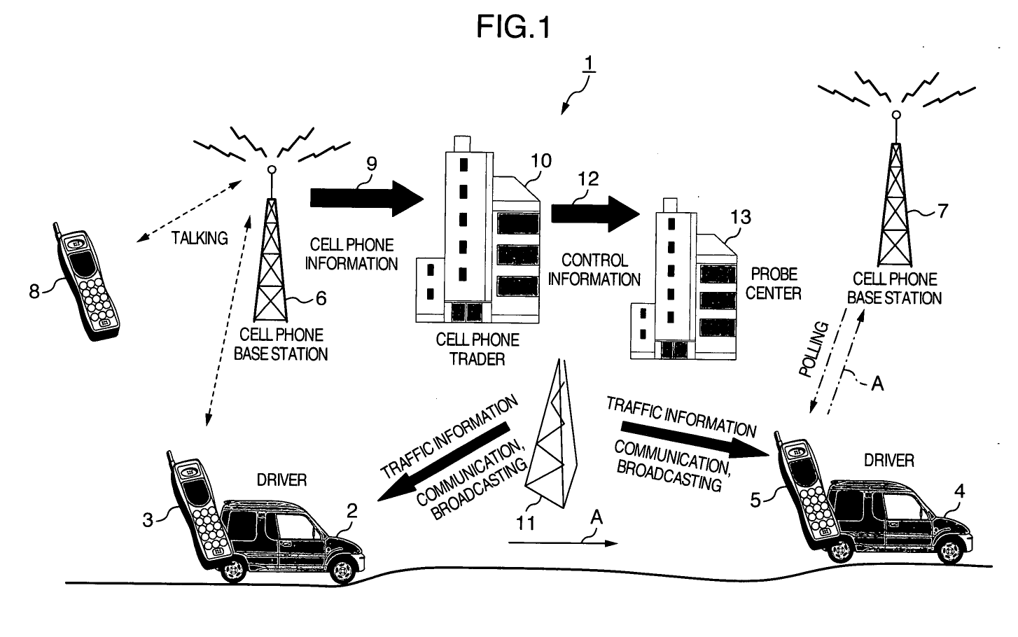

Referring now to FIG. 1, an embodiment of data processing system 1 for probe traffic information and data processing method for probe traffic information according to the invention is illustrated.

As shown in FIG. 1, a driver carrying a cell phone (cellular phone) 3 is on board a car 2. Likewise, a driver carrying a cell phone (cellular phone) 5 is on board a car 4 running on the same road. The cell phone 3 enters a communication area of a cell phone base station 6 and the cell phone 5 enters a communication area of a cell phone base station 7. Accordingly, the cell phone 3 communicates with another cell phone through the cell phone base station 6 and the cell phone 5 communicates with a different cell phone through the cell phone base station 7.

Illustrated in FIG. 1 is a state that the driver on board the car 2 communicates with another cell phone 8 by using the cell phone 3. When the different cell phone 8 is called up by the cell phone 3 or when the cell phone 3 is called up by the cell phone 8, cell phone information of cell phone 3 is acquired from the cell phone 3 at a point where talking between the cell phones 3 and 8 is started. More specifically, data which can be grasped by the cell phone base station 6, including an identification number of cell phone, an origination time, a talking end time and use information of one of a plurality of sectors (3 to 6 sectors) defined or established by dividing the communication area of cell phone base station 6, are gathered from the cell phone 3 into the cell phone base station 6.

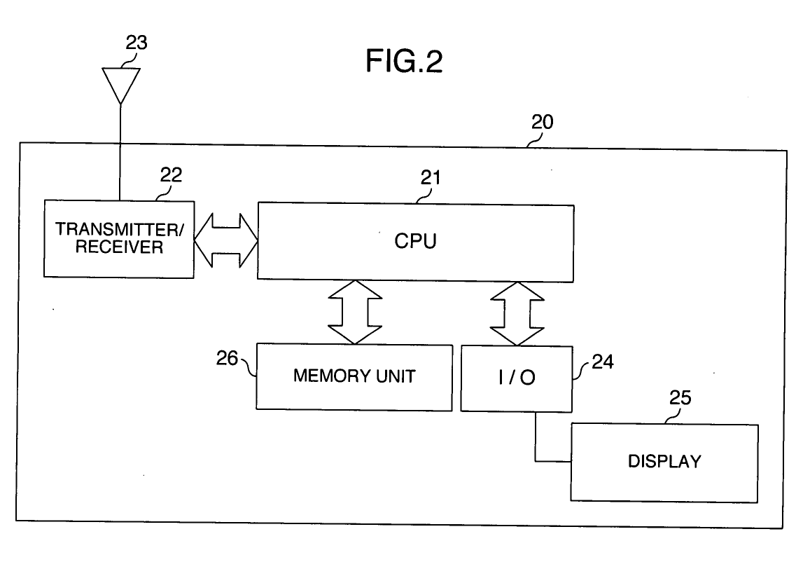

The cell phone base station 6 is an antenna base having a communication area for relaying the cell phone 3 to the cell phone 8 or vice versa and for transmitting necessary data. Data transmitted to the cell phone base station 6 is transmitted to a processor of a cell phone trader 10. The data processor of cell phone trader 10 constitutes a data processing apparatus 20 for probe traffic information constructed as shown in FIG. 2.

Turning to FIG. 2, the data processing apparatus 20 for probe traffic information includes a CPU 21 which executes all kinds of operation processes. The CPU 21 is coupled with a transmitter/receiver 22 through a bus line. The transmitter/receiver 22 has the function to receive a signal transmitted from the cell phone 3 carried by the driver toward the partner cell phone 8 and transmit the signal to the partner cell phone 8 and the function to receive a signal transmitted from the cell phone 8 toward the partner cell phone 3 carried by the driver and transmit the signal to the partner cell phone 3. The transmitter/receiver 22 is also used to broadcast or transmit road information operated in the CPU 21. The data supplied to the transmitter/receiver 22 is transmitted to the cell phone base station 6 through an antenna 23.

The CPU 21 is coupled to an input/output unit (I/O) 24 through a bus line and the I/O 24 is in turn connected with a display 25 for displaying data received from the cell phones 3 and 8, map data and necessary data. Further, the CPU 21 is coupled to a memory unit 26 representing various kinds of databases through a bus line.

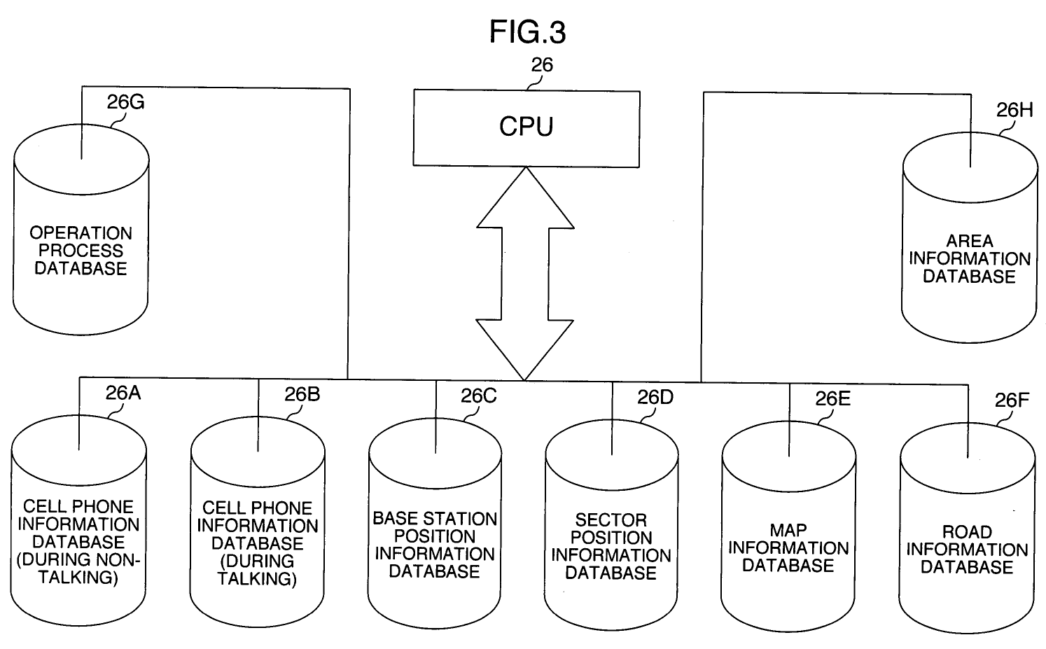

As shown in FIG. 3, the memory unit 26 includes a cell phone information database (during non-talking) 26A, a cell phone information database (during talking) 26B, a base station position information database 26C, a sector position information database 26D, a map information database 26E, a road information database 26F, an area information database 26H and an operation process database 26G.

Information from a cell phone an associated cell phone base station can grasp during non-talking over the cell phone (in a state that communication circuit is not connected to a partner without dialing) is stored and saved in the cell phone non-talking period information database 26A, the information including an identification number (telephone number) of the cell phone obtained therefrom through polling indicative of an inquiry from the cell phone base station 6 to the cell phone during non-talking, a polling response time of the cell phone, the responded cell phone base station, an area within the cell phone base station and position information.

Information from a cell phone an associated cell phone base station can grasp during talking over the cell phone (in a state that talking is started with dialing to a partner, followed by handset-off by the partner, and is ended by handset-on by the partner or dialing party, thus setting up a talking duration time ranging from the talking start to the talking end) is stored and saved in the cell phone talking period information database 26B, the information including an identification number (telephone number) of the cell phone obtained therefrom, an originating time of the cell phone, a talking end time of the cell phone, a talking duration time, the cell phone base station used for talking and an area within the cell phone base station and position information.

Stored and saved in the base station position information database 26C is position information (latitude and longitude) of respective ones of a plurality of cell phone base stations indicating where the individual plural cell phone base stations are located on a map).

Stored and saved in the sector position information database 26D is information for specifying an area range of respective ones of a plurality of sectors obtained by radially dividing respective ones of communication areas of the individual plural cell phone base stations. Also stored and saved in this database is information for radially specifying a plurality of distance areas in each area, starting from the transmission point of the cell phone base station to extend in accordance with levels of the strength of an electric wave.

Stored and saved in the map information database 26E is information of a road map of neighborhoods inclusive of respective ones of the communication areas the plurality of cell phone base stations have.

Stored and saved in the road information database 26F is road information (information indicative of instructions to make a detour because of a road under construction, information indicative of one-side lane alternate traffic because of a road under construction) concerning individual roads running through each communication area each of the plural cell phone base stations has.

Stored and saved in the area information database 26H is area information (data indicative of a communication permissible range) of individual sectors of each communication area each of the plurality of cell phone base stations has.

Stored and saved in the operation process database 26G are results of operation by the CPU 21 obtained for a cell phone during talking, for instance, which are a traveling distance of a cell phone carrier between two points calculated from detection values of positions of two points in association with one cell phone base station or a plurality of cell phone base stations, a traveling time of the cell phone carrier calculated from talking start time and talking end time in association with a plurality of cell phone base stations and a traveling speed (speed per hour) of the cell phone carrier calculated from the traveling distance and traveling time.

In the CPU 21, a cell phone base station, stored in the cell phone talking period information database 26B and having a communication area associated with a cell phone being in use at origination time and talking end time of the cell phone, is specified, a use sector in the communication area of the cell phone base station is specified, a distance between the cell phone base station relaying transmission of the cell phone in use and the cell phone is calculated, information of a point on the road at the time of origination of the cell phone and information of a point on the road at the time of end of talking over the cell phone are calculated on the basis of electronic information of routes on roads in the map information of neighborhoods inclusive of the communication area stored in the map information database 26E, a plurality of candidates for traveling routes necessary for reaching the point at the talking end time from the point at the talking start time are determined on the basis of the point information at the talking start time and the point information at the talking end time by taking into account route information of roads running through the communication area (concerning one-side lane passage and traffic regulation of legal speed) which is stored in the road information database 26F, average running speeds on respective ones of the plural routes are calculated on the assumption that the car runs on the plurality of candidate routes, routes for which values of the respective calculated on-route average running speeds are out of preset upper limit and lower limit values are excluded from the running route candidates, and for routes for which values of average running speeds are within the upper limit and lower limit values, the routes, required times or average speeds are stored and saved in the operation process database 26G, followed by accumulation of the data in the operation process database 26G.

The processor of cell phone trader 10 transmits the data stored and saved in the operation process database 26G to a probe center 13. In the probe center 13, probe traffic information for roads on the map is formed on the basis of the data stored, saved and accumulated in the operation process database 26G. The probe traffic information formed in the probe center 13 is transmitted to individual drivers by way of communication, broadcasting and the like based on electric waves through a relay station 11.

In the illustration of FIG. 1, the driver on board the car 4 is so conditioned as not to use the cell phone 5 during non-talking, with the cell phone 5 being associated with the communication area of cell phone base station 7. Not being in use and talking without making a call to another cell phone (without dialing), the cell phone 5 does not access the cell phone base station 7 positively.

So long as its power supply is turned on, the cell phone periodically makes a request to a nearby cell phone base station for update of existing position (position registration) in order that the position of its own can be recognized by a cell phone network to get ready for replying to a connection request from another phone. This request is made for the purpose of making the cell phone network always know the cell phone base station area in which the cell phone of its own is present.

In FIG. 1, the cell phone 5 periodically makes a position registration request A to the call phone base station 7. In accordance with the position registration request A from the cell phone 5, the cell phone base station 7 acquires position information of the cell phone 5 at the time of this position registration request and position information of the cell phone 5 at the time of the next position registration request. In this phase, the processor of cell phone trader 10 constantly grasps a cell phone base station nearby the cell phone 5 (in the foregoing, the cell phone base station 7 is the nearby station and subsequently, as the car moves, another cell phone base station stands for a nearby station). The processor of cell phone trader 10 constitutes the data processing apparatus for probe traffic information as shown in FIG. 2 and in the processor of cell phone trader 10, a cell phone base station having a communication area associated with the cell phone 5 is specified pursuant to the position registration from the cell phone 5, a use sector in the communication area of the cell phone base station is specified, a distance from the cell phone base station at the time of initial position registration to the cell phone 5 is calculated, a distance from the cell phone base station at the time of the next position registration to the cell phone 5 is calculated, a plurality of candidates for traveling routes necessary for the car to reach from a point of the cell phone 5 at the time of the initial position registration to a point of the cell phone 5 at the time of the next position registration are determined by taking into account route information on roads (information concerning one-side lane passage and traffic regulation of legal speed) running through the communication area which is stored in the road information database 26F, average running speeds on the respective ones of the plural routes are calculated on the assumption that the car runs on the plurality of candidate routes, routes for which values of the respective calculated on-route average running speeds are out of preset upper and lower limit values are excluded from the running route candidates, and for routes for which values of average running speeds are within the preset upper and lower limit values, the routes, required times or average speeds are stored and saved in the operation process database 26G, followed by accumulation of the data in the operation process database 26G.

The data obtained from the cell phone during non-talking and stored and saved in the operation process database 26G is sent to the probe center 13 from the processor of cell phone trader 10. In the probe center 13, probe traffic information on roads existing on the map is formed on the basis of the data stored, saved and accumulated in the operation process database 26G. The probe traffic information formed in the probe center 13 is sent to individual drivers by way of communication, broadcasting or the like based on electric waves through the relay base 11.

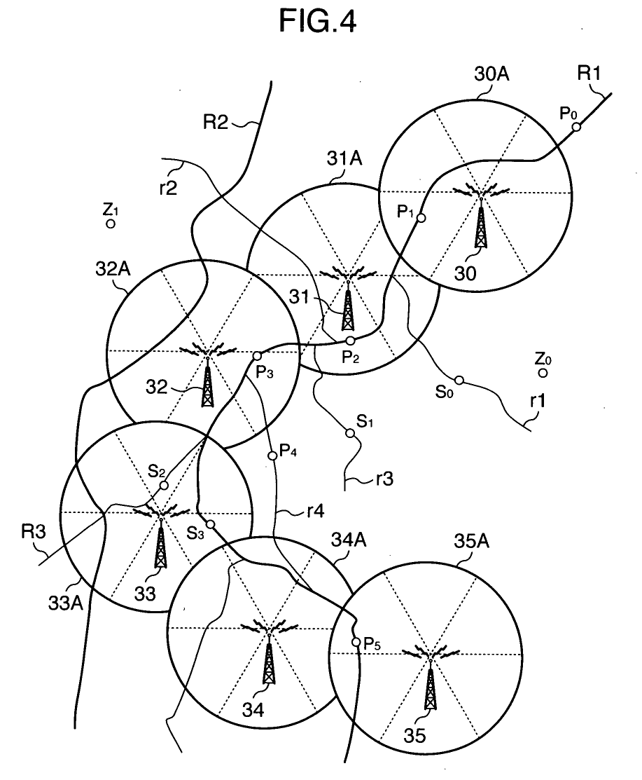

Referring now to FIG. 4, a method for acquiring probe information will be described. In connection with FIG. 4, an instance will be described in which a driver of a car running on a trunk road R1 places a cell phone in talking condition. In FIG. 4, the car is passing through a start point P0.

In FIG. 4, cell phone base stations 30, 31, 32, 33, 34 and 35 are installed forwardly of the start point P0 along the trunk road R1. The cell phone base stations 30 to 35 have communication areas 30A, 31A, 32A, 33A, 34A and 35A, respectively.

On the way, the trunk road R1 in FIG. 4 branches to branch roads r1 to r4 and to a trunk road R3. In addition, a trunk road R2 runs in the same direction as the trunk road R1.

It is assumed that in FIG. 4 the car runs on the trunk road R1. As the car running on the trunk road R1 enters the communication area 30A of cell phone base station 30 after having passed through the start point P0 on trunk road R1, the driver of the car rings up the cell phone at a point P1. Then, an identification number of the cell phone, an origination time of the cell phone, the cell phone base station used for talking, an area belonging to the cell phone base station and position information, which data are obtained from the cell phone at the time of start of talking over the cell phone, are grasped by the processor (data processing apparatus for probe traffic information) of cell phone trader 10. Then, the cell phone base station is recognized as the cell phone base station 30 having received an electric wave of the cell phone transmitted by the driver of the car and it is detected as to which one of sectors of the communication area 30A of cell phone base station 30 the car is present in. Further, it is specified, from a level of strength of the cell phone electric wave received by the cell phone base station 30, as to which one of zones in the sector of the communication area 30A of cell phone base station 30 the car is running in and this information is grasped as position information. This operation for specifying is carried out by the processor (data processing apparatus for probe traffic information) of cell phone trader 10.

Then, the cell phone starts communication by using the cell phone base station 30 as an associated base station and position detection of the cell phone is executed. Assumptively, the cell phone enters the communication area 35A of cell phone base station 35 without being rung off, thus continuing to be rung up until a point P5 is reached where talking ends. During this interval, each time that handover of the respective cell phone base stations (switching of a cell phone base station to an adjoining cell phone base station) takes place, probe information based on talking over the cell phone of the car driver is given by causing the next cell phone base station to detect a position of the cell phone so as to provide the detected position of the cell phone. In this manner, positions of main points ranging from the point P1 at which talking is started in the communication area 30A of cell phone base station 30 to the point P5 at which talking is ended in the communication area 35A of cell phone base station 35 and times at which the car passes by the main points can be detected and traveling distance and traveling time throughout the route can be measured. A speed of the car (speed per hour) is calculated from the traveling distance and the traveling time. The thus calculated car speed (speed per hour) is accumulated in the operation process database 26G of the data processing apparatus 20 for probe traffic information of cell phone trader 10.

The foregoing description has been given by taking an instance where the cell phone carrier is a car driver. However, not all persons on board a car are drivers and in some case, a person sitting on the assistant driver's seat, passengers on a taxi or passengers on a bus are involved. Then, when even a cell phone carrier on board a car other than the driver rings up a cell phone for talking while being on board the car, the situation is equivalent to the fact that the car driver rings up the cell phone for talking and probe information based on talking over the cell phone can be used. Accordingly, all of cell phone carriers performing talking over cell phone during being on board a car are targeted by probe information based on talking over cell phone.

Thus, all cell phone carriers contribute to gathering probe information based on talking over cell phone. For this reason, it cannot be specified from a cell phone whether a carrier of the cell phone performing talking over the cell phone is walking, stopping on a road, riding on a bicycle or moving by a car. Therefore, a decision is made as to what type the information obtained during talking over the cell phone belongs to. More specifically, in connection with a cell phone during talking, information indicative of a traveling distance “0” of a cell phone carrier between two points calculated from position detection values of the two points in one cell phone base station or over plural cell phone base stations demonstrates that the cell phone carrier is making a call while staying home or while not moving and therefore, the information is excluded from probe information based on talking over the cell phone. Further, in connection with a cell phone during talking, for information not indicative of a traveling distance “0” of a cell phone carrier between two points calculated from position detection values of the two points in one cell phone base station or over plural cell phone base stations but indicative of very slow movement, a traveling distance of the cell phone carrier is calculated, a traveling time of the cell phone carrier is calculated from talking start and end times over the plural cell phone base stations in the course of talking over the cell phone and a traveling speed (speed per hour) is calculated from the traveling distance and traveling time, followed by storage and saving of a calculated value of traveling speed in the operation process database 26G of the data processing apparatus 20 for probe traffic information of cell phone trader 10. The calculated value being very slower than the lowest speed (speed per hour) of a car running on the trunk road R1 is so determined as to indicate talking during stopping of the car on the side of road, talking during walking of the cell phone carrier or talking during riding on a bicycle and is excluded from probe information based on talking over the cell phone. Specifically, the lowest speed may be 5 km/hour. Namely, the calculated traveling speed being slower than 5 km/hour is so determined as to indicate talking during stopping of the car on the side of road, talking during walking of the cell phone carrier or talking during riding of the cell phone carrier on a bicycle and excluded from probe information based on talking over the cell phone.

In this manner, the probe information based on talking over cell phone during traveling of a car is specified. In connection with the information as above, pieces of data of traveling time of the cell phone carrier based on talking over the cell phone moving in a specified zone X on the trunk road R1 for, for example, ten minutes between 9:00 A.M. and 9:10 A.M. on X day of Y month are totalized. Then, traveling time data of the cell phone carrier based on talking over the cell phone moving in the specified zone X on trunk road R1 is obtained. But, an undefined person such as a person going on foot, a person riding on a bicycle or a person driving on the car can personate the cell phone carrier responsible for talking over the cell phone moving in the specified zone X on the trunk road R1 and as described previously, data indicative of the traveling time of the cell phone carrier not corresponding to movement of the car running in the specified zone X on the trunk road R1 are all neglected. The remainder of the data indicative of traveling times of cell phone carriers moving in the specified zone X on the trunk road R1 indicates traveling of the car. This data determines data of traveling time of the cell phone carrier based on talking over the cell phone on board the car running in the specified zone X on the trunk road R1.

Plural pieces of data indicative of traveling times of the cell phone carrier are frequently concentrated on a specified traveling time zone (for example, 25 to 30 minutes). The values concentrated on the specified traveling time zone (for example, 25 to 30 minutes) can be determined as indicating time necessary for the cell phone carrier to move in the specified zone X on the trunk road R1 at present. An average value of the plural data pieces of traveling time of the cell phone carrier is calculated and the calculated average traveling time is determined as indicating time necessary for traveling by car in the specified zone X on the trunk road R1 at present. On the basis of the time necessary for traveling by car in the specified zone X on the trunk road R1, a traveling speed is calculated from a traveling distance, thereby providing a traveling speed (speed per hour) of running by the car in the specified zone X on the trunk road R1 at present. The thus calculated traveling speed (speed per hour) is compared with a predetermined speed (for example, the legal speed stored in the road information database 26F, a normal average running speed of a car running in the zone and the like) and a “jam” is determined when the traveling speed (speed per hour) is slightly slower than the predetermined speed (for example, 25% slower than the predetermined speed), a “congestion” state is determined when the traveling speed (speed per hour) is far slower than the predetermined speed (for example, more than 25% up to 50% slower than the predetermined speed) and “normal” is determined in other cases. The jam information and congestion information are presented to the driver. For presentation, the information may be transmitted directly to the driver or distributed to the driver by way of a management company.

Subsequently, though not illustrated, pieces of probe information based on talking over cell phones moving together with many cars are stored and saved in an external memory device connected to the data processing apparatus 20 for probe traffic information of cell phone trader 10. The information pieces stored and saved for one year in the external memory device connected to the data processing apparatus for probe traffic information of cell phone trader 10 are collected and on the basis of these information pieces, probe traffic information pieces (congestion information and jam information) on roads throughout the country are classified by the month, week, day and time zone in a year and used.

Next, a description will be given by way of example in which a driver of a car running on the trunk road R1 sets a cell phone to non-talking. Initially, the car passes the start point P0.

In FIG. 4, as the car enters the communication area 30A of cell phone base station 30 after having passed the start point P0 on the trunk road R1, the cell phone makes a request to its nearby cell phone base station 30 for position registration. The position of the cell phone is detected for position registration at the point P1 by the cell phone base station 30 and subsequently the position of the cell phone is again detected for position registration at the point P2 by the cell phone base station 31. The position detection is carried out at the two points P1 and P2 and a distance between these points is operated from map data. Then, the processor (data processing apparatus for probe traffic information) of cell phone trader 10 grasps an identification number of the cell phone obtained therefrom when the cell phone has made the position registration request, the cell phone base station having received the position registration request, an area inside the cell phone base station and position information. It is then grasped that the cell phone base station 30 stands for one cell phone base station to which the cell phone carried by the car driver has made the request for position registration and it is detected which one of sectors in the communication area 30A of cell phone base station 30 the cell phone is present in. Further, it is specified, from the strength of electric wave of the cell phone received by the cell phone base station 30 during the position registration request, which one of zones in the sector of the communication area 30A of cell phone base station 30 the cell phone is present in and the thus obtained information is grasped as position information. The above specifying operation is carried out by means of the processor (data processing apparatus for probe traffic information) of cell phone trader 10.

At the same time, an interval between time for request for position registration at the point P1 and time for request for position registration at the next point P2 is measured. From the distance and interval, a running speed is calculated. If, in this phase, the car moves to a point Z0 or S0 after having started from the point P0 and passed through the point P1 on the trunk road R1, the car deviates from the communication area of the cell phone base station and the probe traffic information cannot be set up.

In this manner, the distance from the position registration request start point P1 in the communication area 30A of cell phone base station 30 to the next position registration request point P2 in the communication area 31A of cell phone base station 31 and the traveling time are detected, so that the traveling distance and traveling time can be measured as a whole. From the thus calculated traveling distance and traveling time, a speed (speed per hour) of the car can be calculated. The calculated car speed (speed per hour) is accumulated in the operation process database 26G of data processing apparatus 20 for probe traffic information of the cell phone trader 10.

The foregoing description has been given by taking the case where the cell phone carrier is a car driver. But not all persons on board a car are drivers and there are sometimes a person sitting on the assistant driver's seat, a passenger on board a taxi or passengers on board a bus. In connection with a cell phone carrier other than the driver on board the car, the cell phone carrier on board the car can be detected in its position in the same way as that for position detection of the cell phone carried by the car driver and the detected position can be used as probe information based on the cell phone position registration request. Accordingly, all cell phone carriers on board the car being engaged in polling are targeted by probe information based on talking over cell phone.

Thus, all cell phone carriers contribute to gathering probe information based on cell phone position registration request. For this reason, it cannot be specified from the cell phone whether a carrier of the cell phone for which the position registration request is made is walking, stopping on a road, riding on a bicycle or moving by a car. Therefore, a decision is made as to what type the information obtained during talking over the cell phone belongs to. More specifically, in connection with a cell phone whose position is detected, information indicative of a traveling distance “0” of a cell phone carrier between two points calculated from position detection values at the two points in one cell phone base station or over plural cell phone base stations demonstrates that the cell phone position is detected for a cell phone carrier not being out or not moving and the information is excluded from probe information based on cell phone position detection. Further, in connection with a cell phone whose position is detected, for information not indicative of a traveling distance “0” of a cell phone carrier between two points in one cell phone base station or over plural cell phone base stations but indicative of very slow movement, a traveling distance of the cell phone carrier is calculated, a traveling time of the cell phone carrier is calculated from position detection times over the plural cell phone base stations and a traveling speed (speed per hour) is calculated from the traveling distance and traveling time, followed by storage and saving of a calculated value of traveling speed in the operation process database 26G of data processing apparatus 20 for probe traffic information of the cell phone trader 10. The calculated value being very slower than the lowest speed (speed per hour) of a car running on the trunk road R1 is so determined as to indicate that the position detection is executed during stopping of the car on the side of road, walking of the cell phone carrier or riding of the cell phone carrier on a bicycle and is excluded from probe information based on cell phone position detection. Specifically, the lowest speed may be 5 km/hour. Namely, the calculated traveling speed being slower than 5 km/hour is so determined as to indicate talking during stopping of the car on the side of road, talking during walking of the cell phone carrier or talking during riding of the cell phone carrier on a bicycle and excluded from probe information based on talking over cell phone.

As the car moves from the point P2 to the point P3, the cell phone the car driver has enters the communication area 32A of cell phone base station 32. In moving from the point P2 to point P3, a running speed between the points P2 and P3 is calculated similarly from distance and time. When the moving destination of the car running on the trunk road R1 is now set by designating the point S2 or S3 in the communication area 33A of cell phone base station 33, time required for the car to run from the point P3 to the point S2 or S3 is presented from the designated probe traffic information. But when the car is running to the point P4 on the branch road r4 and the point P4 is designated, handover takes place and time required for running to the point P4 is not presented. Subsequently, the car runs on the branch road r4, enters the communication area 34A of cell phone base station 34, returns again to the trunk road R1 and enters the communication area 35A of cell phone base station 35. Then, probe traffic information can again be obtained through position detection.

In this manner, the probe information based on cell phone position detection during traveling of a car is specified. In connection with the information as above, pieces of data of traveling time of the cell phone carrier based on position detection of the cell phone moving in a specified zone X on the trunk road R1 for, for example, ten minutes between 9:00 A.M. and 9:10 A.M. on X day of Y month are totalized. Then, traveling time data of the cell phone carrier based on position detection of the cell phone moving in the specified zone X on trunk road R1 is obtained. But, an undefined person such as a person going on foot, a person riding on a bicycle or a person driving on the car can personate the cell phone carrier responsible for position detection of the cell phone moving in the specified zone X on the trunk road R1 and as described previously, data indicative of the traveling times of the cell phone carriers not corresponding to movement of the car running in the specified zone X on the trunk road R1 are all neglected. The remainder of the data indicative of traveling times of cell phone carriers moving in the specified zone X on the trunk road R1 indicates traveling of the car. This data provides data of traveling time of the cell phone carrier based on position detection of the cell phone on board the car running in the specified zone X on the trunk road R1.

Plural pieces of data indicative of traveling times of the cell phone carrier are frequently concentrated on a specified traveling time zone (for example, 25 to 30 minutes). The values concentrated on the specified traveling time zone (for example, 25 to 30 minutes) can be determined as indicating time necessary for the cell phone carrier to move in the specified zone X on the trunk road R1 at present. An average value of the plural data pieces of traveling times of the cell phone carrier is calculated and the calculated average traveling time is determined as indicating time necessary for traveling by car in the specified zone X on the trunk road R1 at present. On the basis of the time necessary for traveling by car in the specified zone X on the trunk road R1, a traveling speed is calculated from a traveling distance, thereby providing a traveling speed (speed per hour) of running by the car in the specified zone X on the trunk road R1 at present. The thus calculated traveling speed (speed per hour) is compared with a predetermined speed (for example, the legal speed stored in the road information database 26F, a normal average running speed of a car running in the zone and the like) and a “jam” is determined when the traveling speed (speed per hour) is slightly slower than the predetermined speed (for example, 25% slower than the predetermined speed) and a “congestion” state is determined when the traveling speed (speed per hour) is far slower than the predetermined speed (for example, more than 25% up to 50% slower than the predetermined speed). The jam information and congestion information are presented to the driver. For presentation, the information may be transmitted directly to the driver or distributed to the driver by way of the management company.

Subsequently, though not illustrated, pieces of probe information based on position detection of cell phones moving together with many cars are stored and saved in the external memory device connected to the data processing apparatus 20 for probe traffic information of cell phone trader 10. The information pieces stored and saved for one year in the external memory device connected to the data processing apparatus for probe traffic information of cell phone trader 10 are collected and on the basis of these information pieces, probe traffic information pieces (congestion information and jam information) on roads throughout the country are classified by the month, week, day and time zone in a year and used.

In the foregoing, the present invention has been described as being limitedly applied to business cars but by making the cell phone specifically personate a person, probe information indicating how much the street is jammed with people can be structured. Further, the present invention can also be applied to ships and trains.

It should be further understood by those skilled in the art that although the foregoing description has been made on embodiments of the invention, the invention is not limited thereto and various changes and modifications may be made without departing from the spirit of the invention and the scope of the appended claims.

1. A data processing system comprising a processor having a CPU and a memory unit and adapted to transmit/receive information from/to a cell phone, wherein
said memory unit of said data processing system includes a cell phone non-talking period information database for storing information obtained from the cell phone during non-talking over said cell phone, a base station position information database for storing position information of respective ones of a plurality of base stations, a sector position information database for storing position information of respective ones of a plurality of sectors defined by dividing a communication area of each of the plural base stations, a road information database for storing road information of roads running through the communication areas of the plural base stations and an area information database for storing area information of each sector each communication area of each base station has, and
wherein, in said data processing system, the area information of each sector each communication area of each base station has is watched at a constant period; and
a traveling speed of the car is calculated from traveling time and traveling distance of said car on the basis of position data before the area information changes and position data after the area information changes to thereby generate traffic information.

2. A data processing system for probe traffic information according to claim 1, wherein the information from the cell phone during non-talking over said cell phone is for making a request to a nearby cell phone base station for registering a position of its own.

3. A data processing system for probe traffic information according to claim 1, wherein when the area information watched at the constant period changes, the car is determined as being in motion.

4. A data processing system for probe traffic information according to claim 1, wherein said memory unit of said data processing system includes a map information database for storing map information of neighborhoods inclusive of the communication areas of said plural base stations.

5. A data processing system for probe traffic information according to claim 1, wherein generation of the traffic information is carried out by comparing the traveling speed with a predetermined speed stored in said road information database and determining a jam when said traveling speed is smaller than said predetermined speed beyond a first predetermined range and a congestion state when said traveling speed is smaller than said predetermined speed beyond a second predetermined range.

6. A data processing system for probe traffic information according to claim 1, wherein drive mode input means is provided for the cell phone and when said drive mode input means is turned on, the information from said cell phone is acquired.

7. A data processing system for probe traffic information according to claim 1, wherein said road information includes running route information and one or two or more pieces of running permissible direction information, road construction work information, legal speed and traffic regulation.

8. A data processing system for probe traffic information according to claim 6, wherein said drive mode input means provided for the cell phone includes a drive switch to permit said cell phone to be operated externally and by turning on said drive switch, cell phone information presented from said cell phone is gathered as probe traffic information at a point where talking over said cell phone is started and at a point where the talking is ended.

9. A data processing system comprising a processor having a CPU and a memory unit and adapted to transmit/receive information from/to a cell phone,
wherein said memory unit of said data processing system includes a cell phone talking period information database for storing information obtained from the cell phone during talking over said cell phone, a base station position information database for storing position information of respective ones of a plurality of base stations, a sector position information database for storing position information of respective ones of a plurality of sectors defined by dividing a communication area of each of the plural base stations, a road information database for storing road information of roads running through the communication areas of the plural base stations, and
wherein, in said data processing system, first cell phone information is acquired which is presented from the cell phone at a point where talking over said cell phone is started; second cell phone information is acquired which is presented from said cell phone at a point where talking over said cell phone is ended; traveling time and traveling distance of said car are calculated on the basis of said first cell phone information and second cell phone information; and a traveling speed of said car is calculated from the traveling time and traveling distance of said car to thereby generate traffic information.

10. A data processing system for probe traffic information according to claim 9, wherein talking over said cell phone is started when a handset of a partner cell phone is rendered off.

11. A data processing system for probe traffic information according to claim 9, wherein talking over said cell phone is ended when a handset of a partner cell phone is rendered on.

12. A data processing system for probe traffic information according to claim 9, wherein a process is carried out in which when said traveling speed is far slower than the lowest speed of a car running on said road or when said traveling speed is so high as to deviate from an initially scheduled range, the information obtained from said cell phone is excluded so as not to be gathered into the probe traffic information.

13. A data processing apparatus for probe traffic information comprising a CPU and a memory unit and adapted to transmit/receive information to/from a cell phone,
wherein said memory unit of said data processing apparatus includes a cell phone non-talking period information database for storing information obtained from the cell phone during non-talking over said cell phone, a cell phone talking period information database for storing information obtained from said cell phone during talking over said cell phone, a base station position information database for storing position information of respective ones of a plurality of base stations, a sector position information database for storing position information of respective ones of a plurality of sectors defined by dividing a communication area of each of the plural base stations, a road information database for storing road information of roads running through the communication areas of the plural base stations and an area information database for storing area information of each sector each communication area of each base station has,
wherein, in said CPU, the area information of each sector each communication area of each base station has is watched at a constant period and when the area information watched at the constant period changes, the cell phone is determined as traveling and a traveling speed of a car carrying the cell phone is calculated from traveling time and traveling distance of said car on the basis of position data before the area information changes and position data after the area information changes, and
wherein, in said data processing apparatus, during talking over the cell phone, first cell phone information is acquired which is presented from the cell phone at a point where talking over said cell phone is started; second cell phone information is acquired which is presented from said cell phone at a point where talking over said cell phone is ended; traveling time and traveling distance of said car are calculated on the basis of the first cell phone information and second cell phone information; a traveling speed of said car is calculated from the traveling time and traveling distance of said car; and the traveling speed is compared with a predetermined speed stored in said road information database to determine either a jam or a congestion state when the traveling speed is smaller than the predetermined speed beyond either a first or a second predetermined range, or a jam when the traveling speed is smaller than the predetermined speed beyond the first predetermined range and a congestion state when the traveling speed is smaller than the predetermined speed beyond the second predetermined range.

14. A data processing apparatus for probe traffic information according to claim 13, wherein said road information includes running route information and one or two or more pieces of running permissible direction information, road construction work information, legal speed and traffic regulation.

15. A data processing apparatus for probe traffic information according to claim 13, wherein drive mode input means is provided for the cell phone, including a drive switch to permit said cell phone to be operated externally and by turning on said drive switch, cell phone information presented from said cell phone is gathered as probe traffic information at a point where talking over said cell phone is started and at a point where the talking is ended.

16. A data processing apparatus for probe traffic information according to claim 13, wherein the talking over said cell phone is started when origination of a partner cell phone is started.

17. A data processing apparatus for probe traffic information according to claim 13, wherein the talking over said cell phone is ended when communication with a partner cell phone is stopped.

18. A data processing apparatus for probe traffic information according to claim 13, wherein a process is carried out in which when said moving speed is low to deviate from the lowest speed of a car running on said road, the information obtained from said cell phone is excluded so as not to be gathered into the probe traffic information.

19. A data processing method for probe traffic information comprising:
a first step of reading, on the basis of log information of cell phones concerning a specified road, which log information is included in information of cell phone carriers based on talking over the cell phones and recorded and saved in a cell phone trader, traveling time and traveling distance of every cell phone carrier between a point where talking is started and a point where the talking is ended;
a second step of calculating a traveling speed of a cell phone carrier from the traveling time and traveling distance of said cell phone carrier read out in the first step;
a third step of putting aside and choosing a value of traveling speed remarkably slower than the lowest speed of a car running on the specified road from the traveling speed of said cell phone carrier calculated in the second step; and
a fourth step of comparing the traveling speed of said cell phone carrier chosen in the third step with a preset speed for the specified road to determine a jam or congestion state when the traveling speed is slower than the preset speed.

20. A data processing method for probe traffic information according to claim 19, wherein said speed is indicated in km/hour.

21. A data processing system comprising a processor having a CPU and a memory unit and adapted to transmit/receive information of a cell phone by means of said processor,
wherein said memory unit of said data processing system includes a sector position information database for storing position information of respective ones of sectors defined by dividing a communication area of respective ones of a plurality of base stations and a road information database for storing road information of roads running through the communication areas of said plural base stations, and
wherein, in said CPU, by consulting the information stored in said sector position information database and road information database, traveling time and traveling distance of a moving body carrying the cell phone are calculated from position data before the information changes and position data after the information changes, and traffic information is generated from the calculated information.

22. A data processing system for traffic information according to claim 21, wherein a traveling speed is determined from the traveling distance and traveling time and the traveling speed is compared with a predetermined value to make a choice according to the moving body.

23. A data processing method for traffic information adapted to process transmission/reception of information to/from a cell phone in a processing apparatus having a CPU and a memory unit, comprising:
storing information of respective ones of a plurality of sectors defined by dividing a communication area of respective ones of a plurality of base stations in a sector position information database;
storing road information of roads running through the communication areas of the plural base stations in a road information database;
calculating traveling time and traveling distance of a moving body carrying the cell phone from position data before the information changes and position data after the information changes by consulting the information stored in said sector position information database and road information database; and
generating traffic information from the calculated information.

24. A data processing method for traffic information according to claim 23, wherein a traveling speed is determined from the traveling distance and traveling time and the traveling speed is compared with a predetermined value to make a choice according to the moving body.
